(19) United States
(12) Patent Application Publication
(10) Pub. No.: US 2013/0286049 A1
(43) Pub. Date: Oct. 31, 2013

(54) AUTOMATIC ADJUSTMENT OF DISPLAY IMAGE USING FACE DETECTION

(71) Applicants: Heng Yang, Shanghai (CN); Xiaoxing Tu, Shanghai (CN); Yong Jiang, Shanghai (CN)

(72) Inventors: Heng Yang, Shanghai (CN); Xiaoxing Tu, Shanghai (CN); Yong Jiang, Shanghai (CN)

(21) Appl. No.: 13/976,759

(22) PCT Filed: Dec. 20, 2011
(86) PCT No.: PCT/CN11/02136

§ 371 Date: Jun. 27, 2013

(51) Int. Cl. G09G 5/38

(52) U.S. Cl. CPC G09G 5/38
USPC 345/649

(57) ABSTRACT

In some embodiments a controller is to determine an orientation of a head of a user relative to a display. The controller is also to adjust an orientation of an image displayed on the display in response to the determined orientation. Other embodiments are described and claimed.

### TECHNICAL FIELD

The inventions generally relate to automatic adjustment of display image using face detection.

### BACKGROUND

Some mobile devices already rotate the display image. Typically, they detect touch action or orientation of the display using three dimensional technologies such as gyroscopes or accelerometers in order to implement rotation of the display image. Such methods are limited, however. For example, if a user changes their head's direction relative to the display but does not move the device itself no rotation of the display image will occur. Additionally, if the user places or rotates the display in a horizontal or near-horizontal position, current solutions typically do not detect the movement and no rotation of the display image is performed.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a system according to some embodiments of the inventions.

FIG. 2 illustrates a system according to some embodiments of the inventions.

FIG. 3 illustrates a system according to some embodiments of the inventions.

FIG. 4 illustrates a system according to some embodiments of the inventions.

FIG. 5 illustrates a flow according to some embodiments of the inventions.

### DETAILED DESCRIPTION

Some embodiments of the inventions relate to automatic adjustment of display image using face detection.

In some embodiments a display image is adjusted (for example, rotated) using face detection. In some embodiments a camera is used to take one or more pictures of one or more users and to analyze the direction of the head of at least one user based on one or more picture. The display image is adjusted (for example, rotated) in response to the analysis of the direction of the head of at least one user.

In some embodiments a controller is to determine an orientation of a head of the user relative to a display. The controller is also to adjust (for example, to rotate) an orientation of an image displayed on the display in response to the determined orientation.

In some embodiments a camera is to capture an image of a user using a device. A controller is to determine an orientation of a head of the user relative to a display in response to the captured image. The controller is also to adjust (for example, to rotate) an orientation of an image displayed on the display in response to the determined orientation.

In some embodiments an image is captured of a user using a device. An orientation of a head of the user relative to a display is determined in response to the captured image. An orientation of an image displayed on the display is adjusted (for example, is rotated) in response to the determined orientation.

In some embodiments an orientation of a head of a user relative to a display is determined. An orientation of an image displayed on the display is adjusted (for example, is rotated) in response to the determined orientation.

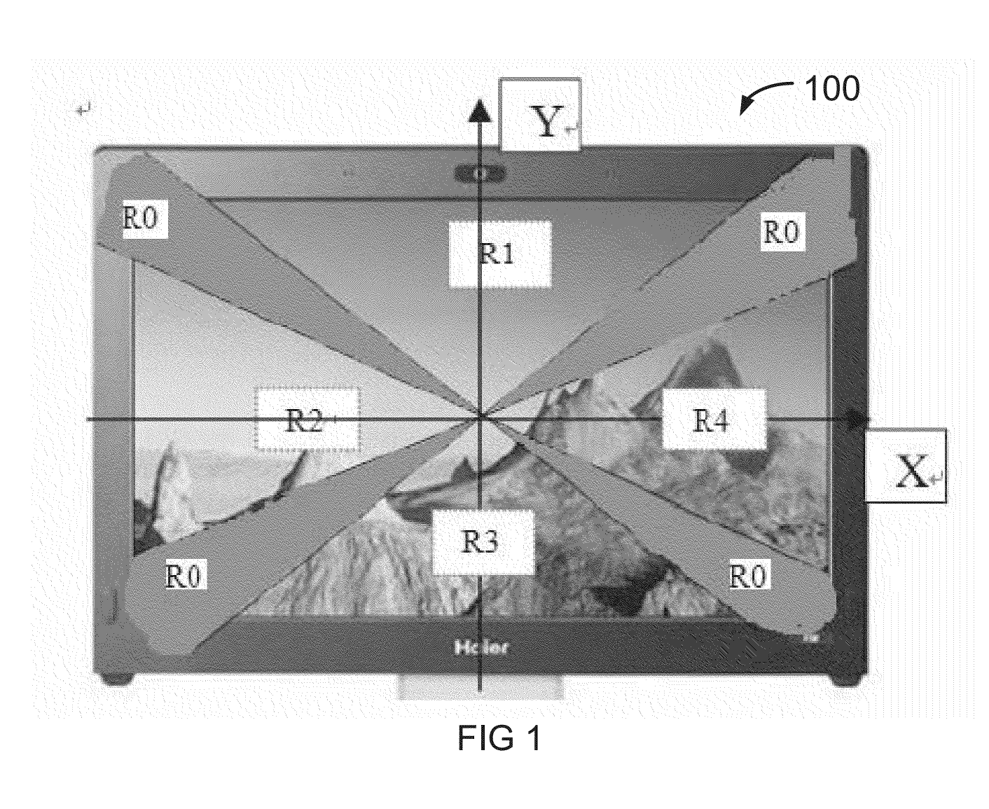

FIG. 1 illustrates a system 100 according to some embodiments of the inventions. In some embodiments system 100 is a display screen. Display screen 100 can be divided into several zones R0, R1, R2, R3, R4, for example, as illustrated in FIG. 1. FIG. 1 illustrates how display screen 100 is referenced using a Cartesian Coordinate System with X and Y axes centered on the display screen 100. For example, zone R0 is an edge range offset on diagonals of the display screen 100 using a range on each side of the diagonal (for example, using a −5 degree and +5 degree range from the diagonal of the display screen 100). In some embodiments, if a user's head direction lies in any of the approximately diagonal ranges R0, no adjustment (for example, rotation) of the display image is implemented. As illustrated in FIG. 1, according to some embodiments, zones R0 fall in a range between 40 to 50 degrees, 130 to 140 degrees, 220 to 230 degrees, and from 310 to 320 degrees, for example. The remaining zones R1, R2, R3, R4 of the display image are used as positions in which a user's head may be determined to be included within, for example, using images of the user's head and calculations of vectors determined by analyzing the images of the user's head, for example. In some embodiments, for example, zone R1 is in a range from 50 to 130 degrees, zone R2 is in a range from 140 to 220 degrees, zone R3 is in a range from 230 to 310 degrees, and zone R4 is in a range from 320 to 360 degrees and from 0 to 40 degrees.

In some embodiments, a camera takes one or more pictures of a user space including a head of at least one user and a controller analyzes one or more of the pictures to obtain a direction (or vector) of the head of the at least one user and to adjust (for example, to rotate) a display image in response to the one or more pictures and to the analysis of one or more of the pictures.

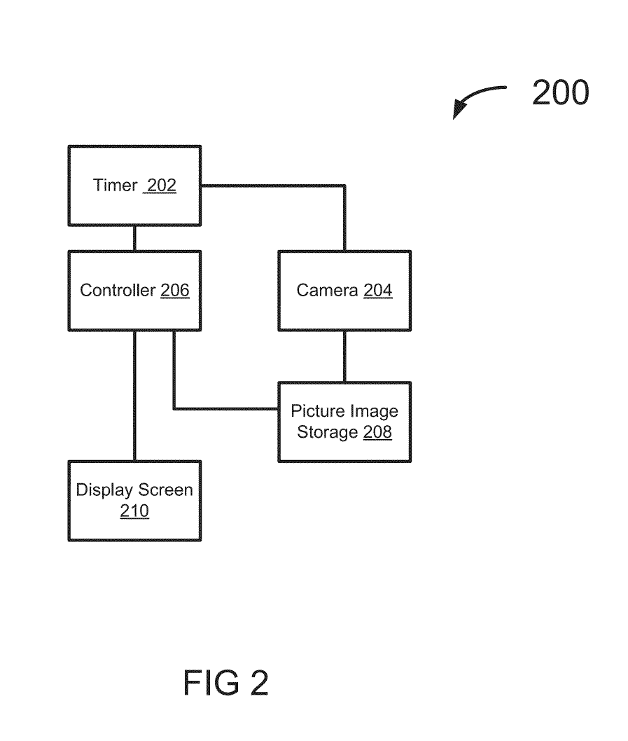

FIG. 2 illustrates a system 200 according to some embodiments. In some embodiments, system 200 includes a timer 202, a camera 204, a controller 206, picture storage 208, and a display screen 210. In some embodiments, timer 202 triggers service by controller 206 at a particular time interval. When the service is triggered by timer 202 and/or controller 206 at the time interval controller 206 controls camera 204 to take a picture. Camera 204 is positioned in some embodiments in a manner that allows it to take a picture of a user space of a user of a device that includes the display screen 210. For example, in some embodiments camera 204 is positioned on or near display screen 210 to capture the user space in which a face of the user of the device might be located when the user is using the device and viewing the display screen 210. Using face detection techniques, for example, controller 206 obtains one or more pictures of the face of one or more users of the device. Controller 206 selects the biggest face in the one or more pictures and uses that face for further analysis. If no face is in the user space then the controller does not perform any further analysis on the picture or pictures.

In some embodiments, in order to obtain a directional position of the head of the user (for example, the biggest head in one or more pictures taken by camera 204 and/or stored in picture storage 208), controller 206 locates the positions of features in the face of the user being analyzed in the picture or pictures (for example, positions of the eyes, nose, and mouth of the user). The positional data is abstracted according to some embodiments using controller 206 into a geometrical shape and/or directional vector data.

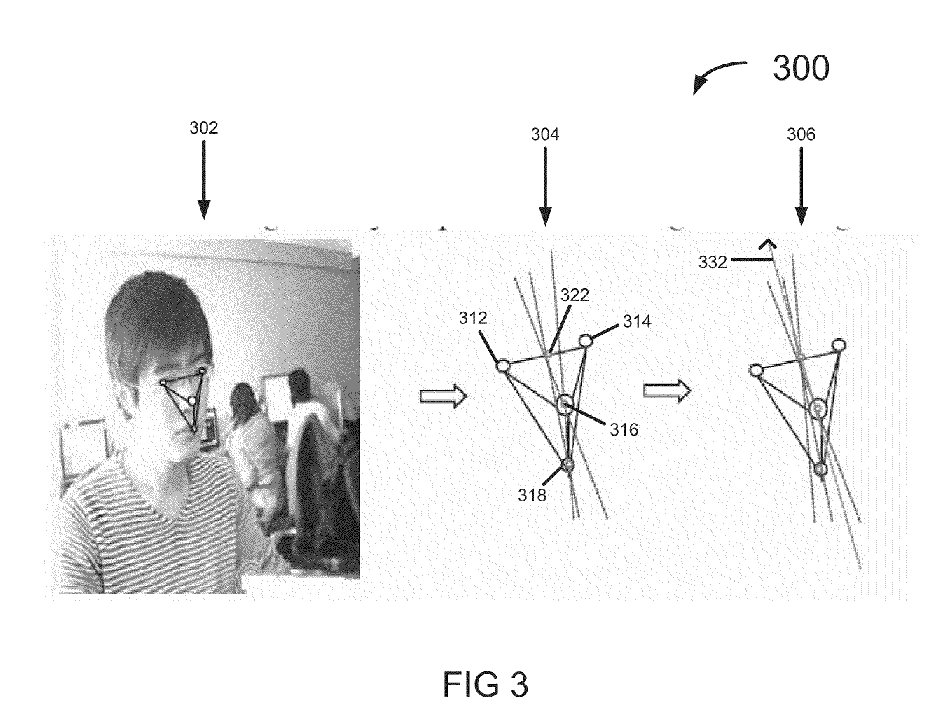

FIG. 3 illustrates a system 300 according to some embodiments of the inventions. System 300 illustrates a picture 302 of a user, a graphical display 304, and a graphical display 306 according to some embodiments. According to some embodiments, picture 302 is a picture taken by a camera such as camera 204 and stored in picture storage such as picture storage 208, for example. Picture 302 includes a picture of a user in a user space. Controller 206, for example, uses face recognition techniques to identify the eyes, nose, and mouth of the user in picture 302. Small circles are illustrated in picture 302 to illustrate the identified eyes, nose, and mouth.

Graphical display 304 illustrates the similar data points of the eyes 312 and 314, nose 316, and mouth 318 from picture 302, and further adds a middle point 322 between the two eyes 312 and 314. A controller such as controller 206 obtains, for example, data points of the middle point 322 between the eyes, the nose point 316, and the mouth point 318 according to some embodiments. Three lines (or vectors) may also be calculated (for example, by controller 206) according to some embodiments. Three lines (or vectors) according to some embodiments are illustrated in graphical representation 304, and include a first line (or vector) between the nose point 316 and the middle point 322 between the eyes, a second line (or vector) between the mouth point 318 and the middle point 322 between the eyes, and a third line (or vector) between the mouth point 318 and the nose point 316.

Graphical representation 306 illustrates how the three lines (or vectors) illustrated in graphical representation 304 are averaged to form a vector 332 illustrated in graphical representation 306 (for example, according to some embodiments, the vector 332 is determined using a controller such as controller 206). Vector 332 has a corresponding direction in a Cartesian Coordinate System such as, for example, that illustrated in FIG. 1, and it is then determined (for example, using controller 206) which zone the vector 332 lies in (and/or points to). In response to this zone determination a display image (for example, on a display screen such as display screen 210) is adjusted (and/or rotated) if the display image is not already in that zone. For example, in system 300, the vector 332 illustrates that the display image on the display screen should be adjusted to be in zone R1 illustrated in FIG. 1. Since the head in picture 302 lies in and/or points upward toward zone R1 in the Cartesian Coordinate System of FIG. 1, the desired display image is determined as such. If the display image of the display screen is already in the zone R1 orientation, then no adjustment is necessary. However, if the display image of the display screen is in another zone orientation, then the display image is adjusted (and/or rotated) to a zone R1 orientation.

In some embodiments, other features of a user's head may be used. For example, according to some embodiments two points of the eyes, nose, and mouth are used to determine head position and orientation (although some precision may be lost). In some embodiments, if only a portion of a user's head is captured in a picture taken by the camera some of the head features are used. If a mouth is not visible in the picture taken by the camera, for example, then the position of the eyes (and/or middle point between the eyes) and the position of the nose are used according to some embodiments.

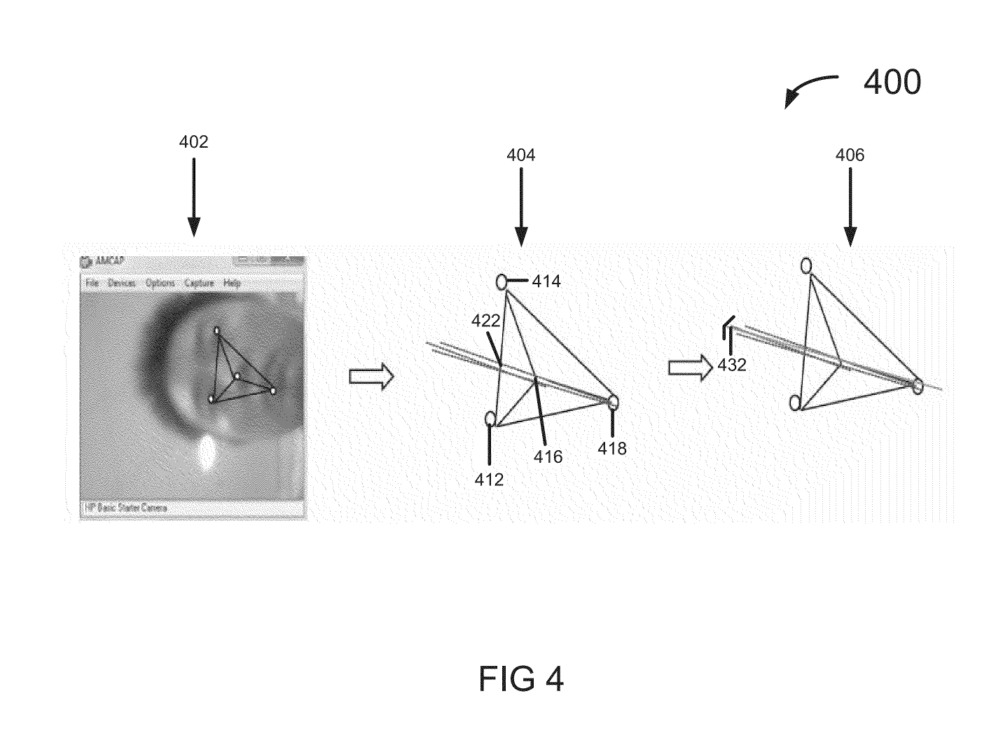

FIG. 4 illustrates a system 400 according to some embodiments of the inventions. System 400 illustrates a picture 402 of a user, a graphical display 404, and a graphical display 406 according to some embodiments. According to some embodiments, picture 402 is a picture taken by a camera such as camera 204 and stored in picture storage such as picture storage 208, for example. Picture 402 includes a picture of a user in a user space. The user's head in picture 402 in FIG. 4 is in a different orientation relative to the camera and the display than the picture 302 in FIG. 3. Controller 206, for example, uses face recognition techniques to identify the eyes, nose, and mouth of the user in picture 402. Small circles are illustrated in picture 402 to illustrate the identified eyes, nose, and mouth.

Graphical display 404 illustrates the similar data points of the eyes 412 and 414, nose 416, and mouth 418 from picture 402, and further adds a middle point 422 between the two eyes 412 and 414. A controller such as controller 206 obtains, for example, data points of the middle point 422 between the eyes, the nose point 416, and the mouth point 418 according to some embodiments. Three lines (or vectors) may also be calculated (for example, by controller 206) according to some embodiments. Three lines (or vectors) according to some embodiments are illustrated in graphical representation 404, and include a first line (or vector) between the nose point 416 and the middle point 422 between the eyes, a second line (or vector) between the mouth point 418 and the middle point 422 between the eyes, and a third line (or vector) between the mouth point 418 and the nose point 416.

Graphical representation 406 illustrates how the three lines (or vectors) illustrated in graphical representation 404 are averaged to form a vector 432 illustrated in graphical representation 406 (for example, according to some embodiments, the vector 432 is determined using a controller such as controller 206). Vector 432 has a corresponding direction in a Cartesian Coordinate System such as, for example, that illustrated in FIG. 1, and it is then determined (for example, using controller 206) which zone the vector 432 lies in (and/or points to). In response to this zone determination a display image (for example, on a display screen such as display screen 210) is adjusted (and/or rotated) if the display image is not already in that zone. For example, in system 400, the vector 432 illustrates that the display image on the display screen should be adjusted to be in zone R2 illustrated in FIG. 1. Since the head in picture 402 lies in and/or points to the left toward zone R2 in the Cartesian Coordinate System of FIG. 1, the desired display image is determined as such. If the display image of the display screen is already in the zone R2 orientation, then no adjustment is necessary. However, if the display image of the display screen is in another zone orientation, then the display image is adjusted (and/or rotated) to a zone R2 orientation.

As discussed above, currently available screen rotation implementations are realized using accelerometer or gyroscope hardware that can detect three dimensional movement to control rotation. However, such implementations cannot deal with movement in a plane and/or where a user does not touch or move the device but merely changes positioning of the user's head relative to the device. According to some embodiments, however, a change in direction of a user's head relative to a display screen is detected and an adjustment (in some embodiments, a rotation) is performed of the display image in response thereto. When a user changes their head direction, the display image on the display screen can be adjusted according to a user's eye position, for example, in order to obtain a better user experience.

According to some embodiments, the display screens described herein in which a display image is adjusted are part of a tablet, an all-in-one PC, a smart phone, an ultrabook, a laptop, a notebook, a netbook, a mobile internet device (MID), a music player, any mobile computing device, or any other computing device.

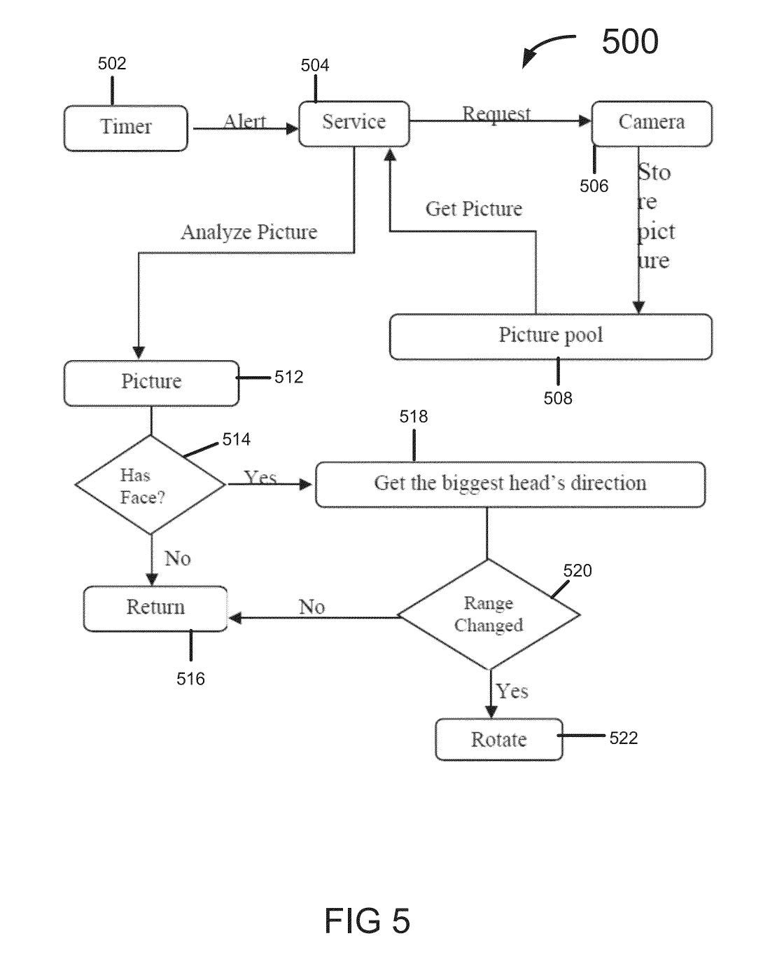

FIG. 5 illustrates a flow 500 according to some embodiments. In some embodiments, for example, some or all of flow 500 is implemented using a controller such as controller 206 of FIG. 2. Flow 500 includes a timer 502 that issues an alert to trigger a service 504 at a short time interval (for example, according to some embodiments, a 0.1 sec time interval). Service 504 (and/or controller 206) sends a request to a camera 506 for camera 506 to take a picture. According to some embodiments camera 506 then takes a picture and stores it in a picture pool 508. Service 504 then receives the picture from picture pool 508 (and/or in some embodiments directly from camera 506) and performs further analysis on the picture as represented at picture 512.

According to some embodiments, service 504 (and/or controller 206) detects all the faces in the picture and makes a determination at 514 as to whether or not the picture includes any faces. If there are not faces then flow 500 returns at 516. If there is at least one face in the picture then the service 504 (and/or controller 206, for example) obtain the biggest head's direction at 518 (for example, using techniques described herein according to some embodiments). The faces are abstracted into geometries, lines, and/or vectors, for example. The direction of the biggest head in the picture is determined according to some embodiments. If the direction of the biggest head is in the zone R0, for example, the flow 500 will quit and/or return at 516. If the zone of the head has changed at 520, then the display image is adjusted (for example, rotated) at 522. If the zone has not changed then service quits and is returned at 516.

Although some embodiments have been described herein as being implemented in a particular manner, according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a controller to determine an orientation of a head of a user relative to a display, and to adjust an orientation of an image displayed on the display in response to the determined orientation.

2. The apparatus of claim 1, wherein the device is a mobile device.

3. The apparatus of claim 1, wherein the device is at least one of a tablet, an all-in-one PC, a smart phone, an ultrabook, a laptop, a notebook, a netbook, a mobile internet device (MID), or a music player.

4. The apparatus of claim 1, further comprising a camera to capture an image of the head of the user, the controller to determine the orientation in response to the captured image.

5. The apparatus of claim 5, wherein the camera is included in or on the device.

6. The apparatus of claim 5, wherein the camera is included in, on, or near the display.

7. The apparatus of claim 1, further comprising a timer, wherein the camera is to capture the image in response to the timer.

8. The apparatus of claim 1, further comprising a storage device to store the captured image.

9. The apparatus of claim 1, wherein the controller is to identify one or more positions of the head of the user in response to the captured image, and to determine the orientation in response to the one or more identified positions of the head of the user.

10. The apparatus of claim 9, wherein the one or more positions of the head include at least one of a position of one or more eyes of the user, a position of a middle point between the eyes of the user, a position of a nose of the user, and a position of a mouth of the user.

11. The apparatus of claim 1, wherein the controller is to identify an orientation of the head of the user by estimating a vector orientation of the head using one or more lines between relative eye, nose, and mouth positions of the user in the captured image.

12. The apparatus of claim 1, the controller to rotate the orientation of the image displayed on the display in response to the determined orientation.

13. A method comprising:
determining an orientation of a head of a user relative to a display; and
adjusting an orientation of an image displayed on the display in response to the determined orientation.

14. The method of claim 13, wherein the device is a mobile device.

15. The method of claim 13, wherein the device is at least one of a tablet, an all-in-one PC, a smart phone, an ultrabook, a laptop, a notebook, a netbook, a mobile internet device (MID), or a music player.

16. The method of claim 13, further comprising capturing an image of the head of the user, wherein the determining of the orientation is in response to the captured image.

17. The method of claim 16, further comprising capturing the image of the head of the user with a camera, wherein the camera is included in or on the device.

18. The method of claim 16, further comprising capturing the image of the head of the user with a camera, wherein the camera is included in, on, or near the display.

19. The method of claim 13, further comprising periodically capturing an image of the user.

20. The method of claim 13, further comprising storing the captured image.

21. The method of claim 13, further comprising identifying one or more positions of the head of the user in response to the captured image, and determining the orientation in response to the one or more identified positions of the head of the user.

22. The method of claim 21, wherein the one or more positions of the head include at least one of a position of one or more eyes of the user, a position of a middle point between the eyes of the user, a position of a nose of the user, and a position of a mouth of the user.

23. The method of claim 13, further comprising identifying an orientation of the head of the user by estimating a vector orientation of the head using one or more lines between relative eye, nose, and mouth positions of the user in the captured image.

24. The method of claim 13, further comprising rotating the orientation of the image displayed on the display in response to the determined orientation.
